(19) United States
(12) Patent Application Publication
(10) Pub. No.: US 2006/0108212 A1
(43) Pub. Date: May 25, 2006

(54) Process for the distillative separation of mixtures of substances

(76) Inventors: Paul Wagner, Dusseldorf (DE); Rolf Feller, Mettmann (DE)

Correspondence Address: LANXESS CORPORATION, 111 RIDC PARK WEST DRIVE, PITTSBURGH, PA, 15275-1112, US

(21) Appl. No.: 11/263,030

(22) Filed: Oct. 31, 2005

(30) Foreign Application Priority Data
Nov. 5, 2004 (DE) 10 2004 054 043.8

(51) Int. Cl. B01D 3/14; B01D 3/42

(52) U.S. Cl. 203/3; 202/153

(57) ABSTRACT

The invention relates to a process for the distillative separation of mixtures of substances, according to the invention the medium boiler and/or high boiler fraction, as the desired product, being freed from low boilers and being obtained directly with the desired composition. In a further aspect, the invention relates to a process for the distillative separation of mixtures of substances, by means of which both a low boiler fraction and a medium boiler and/or high boiler fraction are obtained directly with the desired composition.

The invention relates to a process for the distillative separation of mixtures of substances, according to the invention the medium boiler and/or high boiler fraction, as the desired product, being freed from low boilers and being obtained directly with the desired composition. In a further aspect, the invention relates to a process for the distillative separation of mixtures of substances, by means of which both a low boiler fraction and a medium boiler and/or high boiler fraction are obtained directly with the desired composition.

### BACKGROUND OF THE INVENTION

Thermal separation processes using a column in which either distillate, bottom or side streams are obtained on-spec are sufficiently well known and are summarized, for example, in “Thermische Trennverfahren” [Thermal separation processes] (K. Sattler, 2001 edition, VCH Verlagsgesellschaft, Weinheim).

Frequently, however, not only distillation products having a high purity, i.e. in particular having small proportions of low-boiling components, are being demanded in industrial practice, but more and more frequently also distillation products comprising two or more medium- and high-boiling components which should be as free as possible from low-boiling components and moreover must have an exactly specified composition with regard to the medium- or high-boiling components.

Furthermore, it may even be necessary for both two or more low-boiling components together and two or more medium- and high-boiling components together, in each case as a distillation product of the same distillation, to have a specified purity and composition.

For the recovery of distillation products which must fulfil exactly defined specifications both with regard to their purity and with regard to their composition, usually at least two separation processes in series are necessary, which requires complicated apparatus and logistics. Furthermore, the recovery of such products can frequently also be achieved by adding a component to the initially obtained distillation product in an operation downstream of the thermal separation until the desired composition has been achieved.

In spite of considerable interest in the direct production of distillation products exactly defined with regard to their purity as well as with regard to their composition, by a single thermal separation without a downstream operation (Skogestadt, Trans Chem E, Vol 75, Part A, 1997, pages 539-562), a technically expedient solution therefor has not been described to date in the literature.

There was therefore the need to provide a process for the distillative separation of mixtures of substances which permits the recovery of distillation products which must fulfil exactly defined specifications both with regard to their purity and with regard to their composition.

### SUMMARY OF THE INVENTION

A process for the distillative separation of mixtures of substances has now been found which is characterized in that
a) a column is supplied with at least one feed, and the feed or the feeds is or are separated at least into a low boiler fraction, optionally a medium boiler fraction and a high boiler fraction, the low boiler and/or the medium boiler and/or the high boiler fraction representing the desired product or the desired products, and the desired product or the desired products containing in each case at least two components and
b) a further feed into the column or into liquid circulations directly connected to it is regulated by the composition of the desired product containing at least two components in such a way that the low boiler and/or the medium boiler and/or the high boiler fraction, as the desired product or desired products, have the desired composition and purity,
   the composition of the desired product being determined by repetitive or continuous measurements,
   the feed substantially comprising an optionally vapour component of the desired product or products and
   the regulation of the further feed being effected in such a way that, in order to reduce the proportion of that component of the desired product which is supplied as further feed to the column or to liquid circulations directly connected to it, the supply of a vapour or liquid heating medium to an evaporator connected to the column is increased (indirect supply) or, in order to increase the proportion of that component of the desired product which is supplied as further feed to the column or to liquid circulations directly connected to it, the corresponding feed is increased (direct supply).

It should be pointed out that the scope of the invention also comprises any desired combinations of features and preferred ranges thereof.

According to a), the column is supplied with at least one feed. The supply is preferably effected continuously. If a plurality of feeds are fed in, the feeds may also have a different composition.

The term continuous includes time-related changes of the feed rate as well as temporary interruptions of the feed, as are realized, for example, in the case of a feed changing at intervals or a stepped feed or a feed changing over a predetermined ramp.

According to the separation problem and depending on the position of the feed point, the column serves either as a stripping column, i.e. all theoretical plates are below the feed point (n_{A}=n), as a rectification column, i.e. all theoretical plates are above the feed point (n_{A}=0) or as a column comprising a stripping section or rectification section, i.e. n_{A} theoretical plates are below and n−n_{A} are above the feed point, n being the total number of theoretical plates of the column.

The feed point is preferably chosen so that the column has a stripping section and a rectification section.

The columns known to the person skilled in the art may be used as columns. For example, these are packed columns or tray columns containing unstructured packings or structured packings. If it is intended to take off side stream fractions (medium boiler fractions), the column may also be designed as a dividing wall column or thermally coupled column.

Furthermore, it is also possible to equip the column both with trays and with structured packing elements. For example, structured packings can be used in the rectification section and trays in the stripping section.

The trays, unstructured packings and structured packings which can be used for the process according to the invention are described, for example, in Henry Kister, Distillation Design, McGrawHill, 1992, K. Sattler, Thermische Trenntechnik [Thermal separation technology], Verlag VCH, 2001.

The number of theoretical plates in the column may be, for example, 2 to 150, preferably 4 to 70, particularly preferably 6 to 60.

The column is supplied with a feed which is separated at least into a low boiler fraction, optionally a medium boiler fraction and a high boiler fraction, the low boiler and/or the medium boiler and/or the high boiler fraction representing the desired product or the desired products, and the desired product or the desired products containing in each case at least two components.

The term high boilers and high boiler fractions are to be understood as meaning those substances or mixtures of substances which have a higher boiling point than the optionally present medium boilers and medium boiler fractions, which in turn have a higher boiling point and the low boilers and low boiler fractions. The terms are in each case relative to the mixture of substances which is used for the process according to the invention.

All customary regulation concepts mentioned, for example, by Kister, Sattler and Stichlmair (Distillation—Principles and Practice, Wiley VCH, 1998) for the continuously and discontinuously operated column can be used for automation of the process according to the invention.

According to b), a further feed into the column or into liquid circulations directly connected to it is regulated by the composition of the desired product which contains at least two components. The composition of the desired product is determined by repetitive or continuous measurements. Appropriate online analysis methods have proved to be particularly suitable and are sufficiently well known. The composition can be determined for example by measurement of specific density, pH, velocity of sound, conductivity, light diffraction, light absorption, turbidity or colour number or by recording of NIR spectra or gas chromatograms.

Two mass flows are then controlled by means of the value obtained for the composition of the desired product. One of these is connected directly to the column or to a liquid circulation connected thereto and substantially comprises an optionally vapour component of the desired product or products. For example, a connected liquid circulation comprises at least corresponding pipes, a pump and an evaporator or, in the case of the liquid feeding of the component, a preheater. By regulating this first mass flow, the composition of the desired product is changed in such a way that, for example by an increased feed of one component of the desired product or products, precisely that component is also enriched in the desired product.

The other mass flow leads not to the liquid circulations in and to the column but, as a heating medium stream, controls the evaporation power of an evaporator via which the desired product is passed. By regulating this second mass flow, the composition of the desired product is changed in such a way that, for example by an increased heating medium feed, a lower boiling component of the desired product or products is brought to a lower concentration in the desired product. Evaporators which may be used are all evaporator types known to the person skilled in the art. Falling-film evaporators or thin-film evaporators are preferably used.

In a preferred embodiment of the process according to the invention, the heating medium and the component which is supplied via the further feed to the column or to liquid circulations directly connected to it are identical. Consequently, only one mass feed stream which is divided into the mass flows described above by at least two valves depending on the composition is regulated by measurement of the composition of the desired product or products.

In a likewise preferred embodiment of the process according to the invention, the heating medium and the component which is supplied via the further feed to the column or to liquid circulations directly connected to it are in each case steam. Accordingly, a preferred process is one in which water-containing desired products of exactly specified purity and composition are produced.

On simultaneous establishment of the purity and composition in the low boiler and/or the medium boiler and/or the high boiler fraction, the recycle stream of the low boiler and/or the medium boiler fraction into the column is additionally used for regulating the composition of the low boiler and/or the medium boiler fraction.

According to the invention, the process described is suitable for recovering distillation products which contain at least two components and which fulfil exactly defined specifications both with regard to their purity and with regard to their composition, independently of whether the distillation product is taken off as a high boiler fraction from the column bottom by measurement of the bottom composition and regulation of the bottom take-off amounts, as a medium boiler fraction in a side stream take-off with or without dividing wall by measurement of side stream compositions and regulation of the side stream take-off amounts, or as a low boiler fraction from the top of the column by measurement of distillate stream compositions and regulation of the recycle stream. In a special embodiment, it is also possible to take off two distillation products, i.e. for example the bottom product and the distillate, with desired purity and composition from the column by means of the regulations described.

The process according to the invention is explained by way of example with reference to FIG. 1:

The column 1 is continuously loaded with a mixture of substances comprising the components P (first component of the desired product, high boiler), water (in this case medium boiler, second component of the desired product), LS (low boiler, undesired constituent of the desired product), via a feed valve V1 and the feed 2, which is preferably present in the middle section of the column.

The component LS and water are partly taken off via the top 3 of the column, the pipe 4, the heat exchanger 5, the collecting container 6 and the pipe 7 and partly recycled via the pipe 8 and the valve V2 into the column (1). The components water and P are partly removed as distillation product via the column bottom 9 and via the pump (P1), the pipes 11 and 12 and the valve (V3) connected in between and partly recycled starting from the valve (V3) via the pipe 10, the heat exchanger 14 and the pipe 15 into the column bottom 9.

Depending on the product composition (P+water), which is determined in the pipe 11 by means of a measuring apparatus (M1), steam (16) is fed as a direct steam stream via the pipe 17, the valve (V4) and the pipe 18 into the column bottom 9 and/or as an indirect steam stream via the pipe 19, the valve (V5) and the pipe 20 to the heating medium side of the evaporator 14 and from there into the discharge pipe 21.

The stream of steam as a direct steam stream into the column bottom 9 approximately results in the concentration of P in the distillation product (substantially comprising water and P) decreasing.

The stream of steam as an indirect steam stream and hence as heating medium into the evaporator 14 has approximately the result that the concentration P in the distillation product increases as a result of the evaporation of water.

The process according to the invention is particularly suitable for recovering distillation products which contain at least two components and which have to fulfil exactly defined specifications both with regard to their purity and with regard to their composition. The process according to the invention is very particularly suitable for recovering distillation products in which one component is water.

The invention furthermore relates to a distillation apparatus comprising at least
a column (1) from the upper part (3) of which a discharge pipe (4) leads via a heat exchanger (5) and a pipe (7) to a collecting apparatus of the top product, the pipe (7) leading via a pipe (8) connected to it to a valve (V2), the valve (V2) being connected via the pipe to the column, and
a feed (2) which is controllable by means of a feed valve (V1) and enters the column (1) and
an evaporator (14) which is optionally spatially separated from the column and is connected via the pipes (10) and (11) and (15) to the column, which is characterized in that
the evaporator (14) is connected on the heating medium side via a pipe (20), a valve (V5) and a pipe (19) to a feed for a heating medium (16), and the pipe (19) is furthermore connected via a pipe (17), a valve (V4) and a pipe (18) to the column (1), a measuring station (M1) furthermore being mounted in the circulation comprising at least the column (1), the pipes (11, 10 and 15) and the evaporator (14).

Alternatively, the pipe 8 between the condenser 5 and the container 6 can lead back into the column via the valve (V2).

### EXAMPLES

### Example 1

Establishing the Salt Concentration in the Column Bottom with Isolation of Ammonia Water as a Low Boiler

100 kg/h of a salt solution comprising 50 to 54% by weight of an organic salt and 1 to 3% by weight of ammonia, the remainder being water, were fed into a distillation column having 15 theoretical plates, at the 7th plate from the top. Furthermore, 30 kg/h of ammonia water comprising 10 to 15% by weight of ammonia were fed in at the 2nd plate from the top. Above the column bottom, steam was fed directly into the column, and furthermore water was evaporated from the bottom product via an external evaporator in an amount exactly sufficient to establish a product flow of 124 kg/h having the desired salt concentration of 42% by weight in the bottom. The concentration was determined by a density measurement in the pump circulation (FIG. 1, pipes 10, 11, 15; pump P1) to the evaporator and used as a controlled variable for establishing the indirect steam to the evaporator. By means of the column reflux, it was ensured that a liquid stream having a lower salt concentration always reached the bottom from the column so that the desired concentration was achieved by concentration in the evaporator.

The direct steam flow was established by regulation so that the combination of the direct steam with the steam generated in the evaporator gave, internally in the column, a steam flow of 60 kg/h which was certainly sufficient for isolating the low boiler ammonia from the bottom product to the required purity of <70 ppm.

In addition to establishing the bottom concentration, the concentration of the ammonia water obtained at the top of the column was also adjusted to 24% by weight of ammonia by determining the ammonia content here by means of a density measurement and regulating the amount of reflux into the column accordingly. As a precondition for the simultaneous establishment of top and bottom concentration, the amount of water in the liquid column feeds was less than the amount of water required in the top and bottom product. The lacking water was supplied via the direct steam in the column bottom, the exact amount was automatically established by means of the regulations described above and automatically being further supplied in the feeds even in the case of changes and disturbances.

### Example 2

Establishing the Concentration of a Toluene/Chlorotoluene Mixture at the Column Bottom with Isolation of Benzene

100 kg/h of a mixture consisting of 20% by weight of toluene, 20% by weight of benzene and 60% by weight of chlorotoluene were fed into a distillation column having 20 theoretical plates, at the 5th plate from the top. At the column bottom, a product comprising 50% by weight of chlorotoluene and 50% by weight of toluene and benzene <10 ppm was taken off. For this purpose, the benzene content and the toluene content were determined by suitable online analysis in the column bottom. The vapour flow to the evaporator was regulated by means of the benzene content, and the toluene flew into the pumped circulation to the evaporator by means of the toluene content. At the top of the column, the purity of the benzene was determined by a suitable online analysis and regulated to 98% by weight by means of the amount of distillate taken off.

What is claimed is:

1. A process for the distillative separation of mixtures of substances, wherein
a) a column is supplied with at least one feed, and the feed or the feeds is or are separated into a low boiler fraction and a high boiler fraction, the low boiler and/or the high boiler fraction representing the desired product or the desired products, and the desired product or the desired products containing in each case at least two components and
b) a further feed into the column or into liquid circulations directly connected to it is regulated by the composition of the desired product containing at least two components in such a way that the low boiler and/or the medium boiler and/or the high boiler fraction, as the desired product or desired products, have the desired composition and purity,
the composition of the desired product being determined by repetitive or continuous measurements,
the feed substantially comprising an optionally vapour component of the desired product or products and
the regulation of the further feed being effected in such a way that, in order to reduce the proportion of that component of the desired product which is supplied as further feed to the column or to liquid circulations directly connected to it, the supply of a vapour or liquid heating medium to an evaporator connected to the column is increased (indirect supply) or, in order to increase the proportion of that component of the desired product which is supplied as further feed to the column or to liquid circulations directly connected to it, the corresponding feed is increased (direct supply).

2. A process according to claim 1 wherein in a) the column is supplied with at least one feed and the feed or the feeds is or are separated into a low boiler fraction, a medium boiler fraction and a high boiler fraction.

3. A process according to claim 1 or 2, wherein the heating medium and the component which is supplied via the further feed to the column or to liquid circulations directly connected to it are identical.

4. A process according to claim 1 or 2, wherein in that the heating medium and the component which is supplied via the further feed to the column or to liquid circulations directly connected to it are in each case steam.

5. A process according to claim 1 or 2, wherein, according to b), the high boiler fraction is taken off as the desired product having the desired composition and purity.

6. A process according to claim 1 or 2, wherein, according to b), both the low boiler and the high boiler fraction are taken off as the desired products having the desired composition and purity.

7. A distillation apparatus comprising
a column (1) from the upper part (3) of which a discharge pipe (4) leads via a heat exchanger (5) and a pipe (7) to a collecting apparatus of the top product, the pipe (7) leading via a pipe (8) connected to it to a valve (V2), the valve (V2) being connected via the pipe to the column, and
a feed (2) which is controllable by means of a feed valve (V1) and enters the column (1) and
an evaporator (14) which is connected via the pipes (10) and (11) and (15) to the column, wherein
the evaporator (14) is connected on the heating medium side via a pipe (20), a valve (V5) and a pipe (19) to a feed for a heating medium (16), and the pipe (19) is furthermore connected via a pipe (17), a valve (V4) and a pipe (18) to the column (1), a measuring station (M1) furthermore being mounted in the circulation comprising at least the column (1), the pipes (11, 10 and 15) and the evaporator (14).

8. A distillation apparatus according to claim 7 wherein the evaporator (14) is spatially separated from the column.
